(19) United States
(12) Patent Application Publication
(10) Pub. No.: US 2014/0046836 A1
(43) Pub. Date: Feb. 13, 2014

(54) INFORMATION COMMUNICATION SYSTEM, METHOD THEREOF, AND COMPUTER READABLE MEDIUM

(71) Applicant: Kabushiki Kaisha Toshiba, Tokyo (JP)

(72) Inventors: Yu KANEKO, Yokohama-shi (JP); Shigeo MATSUZAWA, Tokyo (JP); Tomonori MAEGAWA, Tokyo (JP)

(21) Appl. No.: 13/919,254

(22) Filed: Jun. 17, 2013

(30) Foreign Application Priority Data
Aug. 10, 2012 (JP) 2012-178312

(51) Int. Cl. G06Q 30/04

(52) U.S. Cl. CPC G06Q 30/04
USPC 705/40

(57) ABSTRACT

According to some embodiments, there is provided an information communication system including: an information transmitting unit and an information receiving unit. The information transmitting unit transmits first information specifying a power price to a terminal device of a power consumer. The information receiving unit receives second information indicating whether the power consumer has recognized the first information from the terminal device or a different terminal device of the power consumer.

### CROSS REFERENCE TO RELATED APPLICATIONS

This application is based upon and claims the benefit of priority from the prior Japanese Patent Application No. 2012-178312 filed on Aug. 10, 2012, the entire contents of which are incorporated herein by reference.

### FIELD

Embodiments described herein relates to an information communication system, a method thereof, and a computer readable medium.

### BACKGROUND

There is a method of electric power supply and demand control called demand response. Hereinafter, the demand response is described as DR.

In the DR, an electric power supply side (a power supplier) requests a power demand side (a power consumer) to reduce power consumption or change a consumption time period. The power supplier is a power company, and the power consumer is a resident of a building, a house or a plant. A system of the power consumer is notified of a request from a system of the power supplier using a communication technique. Information (DR information) notified as the request includes information on a power price for a certain period. Typically, the certain period is any one day. Also, the power supplier urges the power consumer to reduce power consumption or change a consumption time period by making the power price for a time period (a peak time period) in which power demand reduction is especially desired be higher than the power price for the other time periods.

Generally, the power supplier issues the DR information one day or several days before a start date of a DR target period. The DR target period is one day to several months. The power price included in the DR information is set every 15 minutes or 30 minutes, and the unit is “JPY/kWh” or “USD/kWh” the like (JPY is Japanese currency). In summer, since the power supplier wants to reduce power demand in the daytime, the power price for the daytime is increased and the power price for mornings and for the nighttime is reduced instead. In such a manner, the power consumer is urged to reduce the power consumption. Also, in winter, since it is desired to reduce power demand in the nighttime, the power price for the nighttime is increased.

By grasping the power price set in the DR information and acting to consume power in a time period of a low power price, there is a possibility that the power consumer can reduce an electric bill. To the contrary, when the power consumer cannot grasp the power price, there is a possibility that power is consumed in the peak time period causing increase of the electric bill.

Thus, it is important for the power consumer to check the DR information. However, situations in which the DR information cannot be checked occur for the following reasons.
1. The DR information does not reach the system of the power consumer due to abnormality of the system or a network.
2. Though the DR information has reached the system of the power consumer correctly, the power consumer does not check the DR information.

When billing calculation is performed on the basis of the power price in the DR information and the electric bill is increased even though the DR information cannot be checked, complaints of the power consumer increase. In the case of the reason 1, since the power consumer is not at fault, the complaints especially increase.

The official notice which takes comfort of the power consumer into consideration when determining the power price is known. However, whether or not the power consumer has checked the DR information is not taken into consideration when determining the power price. Thus, in the known example, the above-mentioned problem cannot be solved.

As mentioned above, in the known technique, the power price is determined and charged without considering whether or not the power consumer has checked the DR information. Thus, there is a problem that complaints of the power consumer increase when the power consumer cannot check the DR information.

### BRIEF DESCRIPTION OF THE DRAWINGS

FIG. 1 is a drawing illustrating an example of a demand response (DR) execution environment including a DR issuing system according to this embodiment;

FIG. 2 is a drawing illustrating an internal configuration example of the DR issuing system in this embodiment;

FIG. 3 is a drawing illustrating an example of information stored in an EMS information storage;

FIG. 4 is a drawing illustrating an example of information stored in a DR transmission result storage;

FIG. 5 is a flowchart illustrating flow of DR issuing processing by the DR issuing system;

FIG. 6 is a flowchart illustrating flow of recognition level grasping processing by the DR issuing system;

FIG. 7 is a flowchart illustrating flow of information collecting processing by the DR issuing system;

FIG. 8 is a flowchart illustrating flow of billing processing by the DR issuing system; and

FIG. 9 is a drawing illustrating one example of a DR power price, a correction example thereof, and a usual price.

### DETAILED DESCRIPTION

According to some embodiments, there is provided an information communication system including: an information transmitting unit and an information receiving unit.

The information transmitting unit transmits first information specifying a power price to a terminal device of a power consumer.

The information receiving unit receives second information indicating whether the power consumer has recognized the first information from the terminal device or a different terminal device of the power consumer.

In this embodiment, a recognition level with which a power consumer recognizes DR (demand response) information transmitted to the power consumer is grasped, a power price in the DR information is corrected depending on the recognition level to perform billing calculation, and thus it is made possible to perform billing avoiding increase of complaints of the power consumer.

Hereinafter, embodiments will be described with reference to drawings.

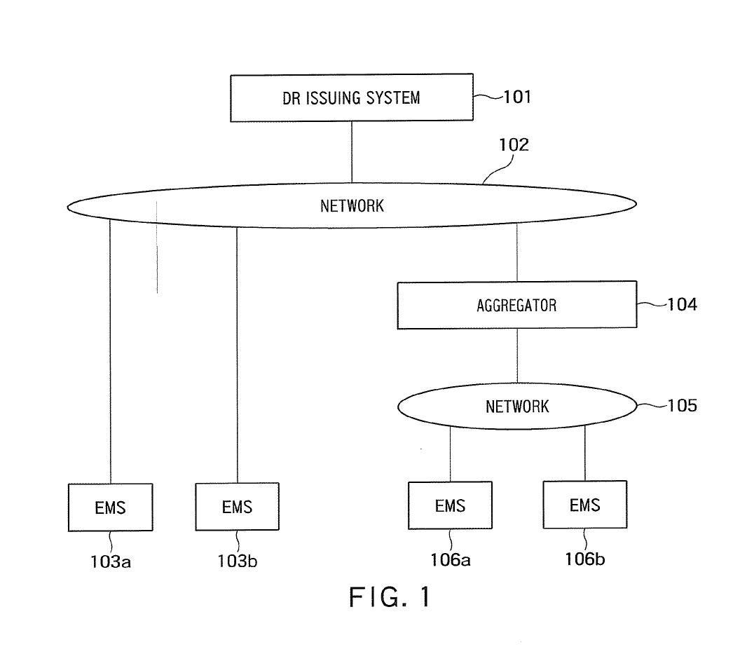

FIG. 1 illustrates an example of a DR execution environment according to an embodiment.

There are three types of system: a DR issuing system 101 which is an information communication system of a power supplier, a system including terminal devices 103a, 103b, 106a and 106b of power consumers, and an aggregator system 104 which aggregates a plurality of energy management systems. The DR issuing system 101 and an aggregator 104 are connected by a network 102, and the aggregator 104 and the terminal devices 106a and 106b are connected by a network 105.

In the example in FIG. 1, as the terminal devices 103a, 103b, 106a and 106b, energy management systems (hereinafter, described as EMSs) of the power consumers are illustrated. The EMS generally manages energy of a structure such as a house or a building. As the EMS, there are a Home Energy Management System (HEMS), a Building and Energy Management System (BEMS) and a Factory Energy Management System (FEMS) or the like. The terminal device is not limited to the EMS and may be a smart meter, a personal computer, a smartphone, a cellular phone or a fixed-line phone when the power consumer is a resident of a house (a general consumer). Hereinafter, descriptions are given assuming that the terminal device of the power consumer is the EMS.

The DR issuing system 101 notifies EMSs of the DR information through two kinds of routes. One is a route through which the DR issuing system directly notifies the DR information. Notification routes to the EMSs 103a and 103b correspond to it. The other is a route through which the DR information is notified through the aggregator 104. Notification routes to the EMSs 106a and 106b correspond to it.

When notifying the DR information through the aggregator 104, the DR issuing system 101 notifies only the aggregator 104 of the DR information. Then, the aggregator 104 transfers the DR information to the subordinate EMSs. When the aggregator 104 is interposed, the DR issuing system 101 can reduce the number of times of notifying the DR information. In this case, it is needed to check that the DR information has correctly reached the EMSs subordinate to the aggregator 104 by inquiring the aggregator 104.

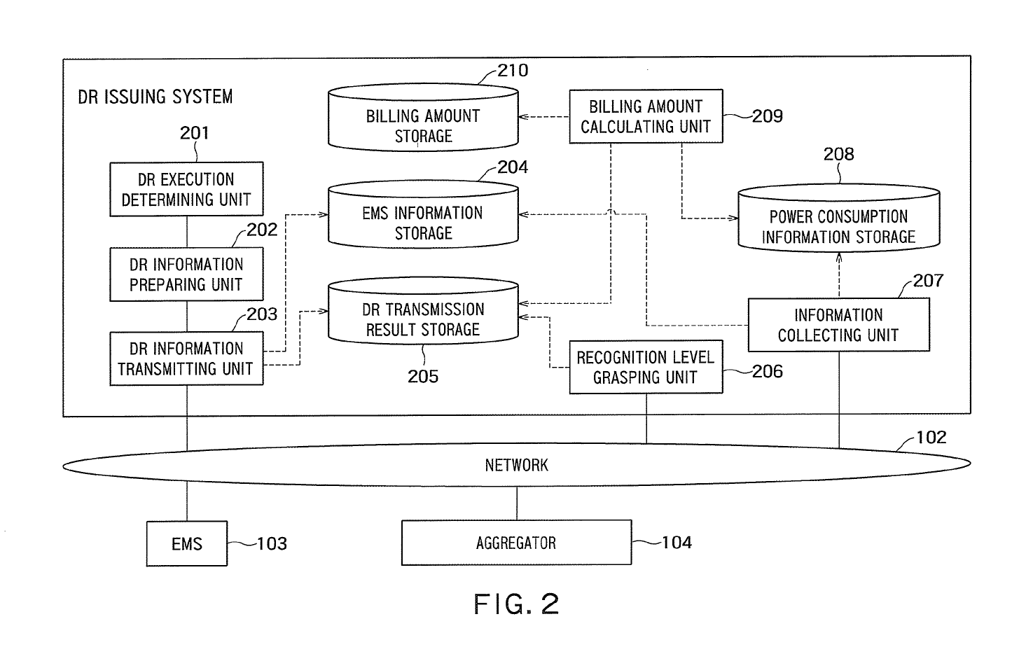

FIG. 2 illustrates an internal configuration example of the DR issuing system 101 in this embodiment. Hereinafter, components are described.

A DR execution determining unit 201 determines that the DR is to be executed to a certain EMS group. A known technique can be utilized for a method of determining to which EMS and when the DR is to be executed. For instance, there are a method of determining that on the basis of predicted values of supply and demand of power, a method of determining that from weather prediction about air temperature, humidity and an amount of solar radiation or the like, and a method of determining them by utilizing all of the information or the like.

An EMS group is formed beforehand on the basis of physical coordinates and power contract or the like. To which group each EMS belongs to is determined beforehand and stored in an EMS information storage 204.

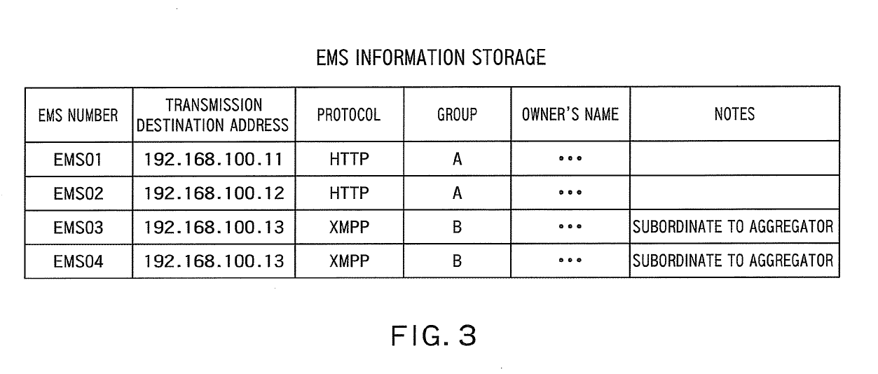

FIG. 3 illustrates an example of information stored in the EMS information storage 204.

In the EMS information storage 204, for each EMS, an address for communication (a transmission destination address), a communication method (a protocol), a group, a name of an owner of the EMS, and whether or not the EMS belongs to the aggregator, or the like are stored.

A transmission method of the DR information is equivalent to a standard specification like an Open Automated Demand Response (Open ADR). That is, the DR information is expressed by Extensible Markup Languages (XML), JavaScript Object Notation (JSON), or Comma Separated Value (CSV) or the like, and is transmitted by the transmission method of HyperText Transfer Protocol (HTTP) or Extensible Messaging and Presence Protocol (XMPP) or the like based on TCP/IP or UDP/IP.

While an example of an IPv4 private address is described as an address in FIG. 3, the address may be a global address or IPv6 address or service address. Also, the transmission destination address of the EMSs belonging to the aggregator is an address of the aggregator and is common in the EMSs.

A DR information preparing unit 202 prepares the DR information (first information). Parameters to be important in the prepared DR information are the DR target period and the power price for the target period. Typically, the target period is a next day or any one day after the next day. Also, the power price for a time period (a peak time period, about 2 hours to 3 hours) which is a part of the target period is a value which is 10 times to 100 times the power price for the other time periods for instance. The other parameters are equivalent to the parameters determined by the standard specification like the Open Automated Demand Response (OpenADR).

A DR information transmitting unit 203 transmits the DR information to the EMSs and the aggregator 104. The transmission method follows the information stored in the EMS information storage 204.

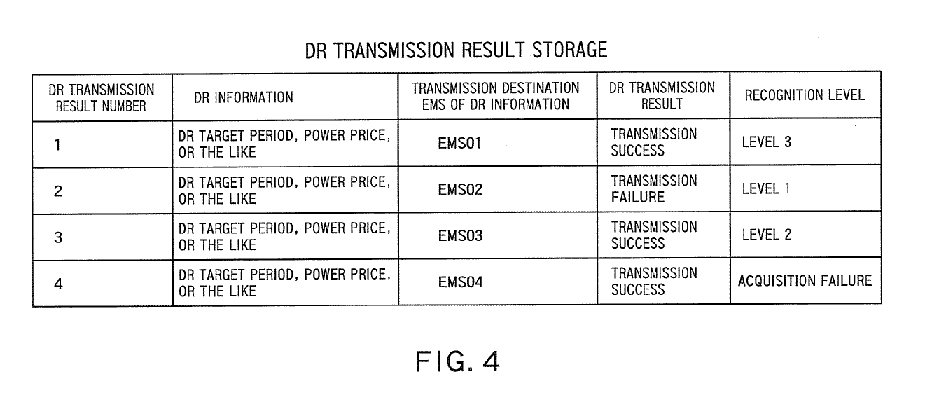

In a DR transmission result storage 205, for the respective EMSs (the EMSs and the EMSs subordinate to the aggregator 104), the DR information transmitted to each of them, success/failure of transmission, and recognition information (second information) indicating whether or not the power consumer has checked the DR information are recorded. An example of the information stored in the DR transmission result storage 205 is illustrated in FIG. 4.

Contents of the DR information recorded in the DR transmission result storage 205 are mainly the DR target period and the power price. Since the power price is set by a time unit such as a unit of 15 minutes or a unit of 30 minutes during the DR target period, in that case, the power price for each unit time is recorded. The information is needed when calculating a bill for the respective EMSs. Also, a configuration of the DR information is not limited to the one described above and the other configuration is also possible. For instance, the configuration for which only the power price is included in the DR information and the DR target period is not included is possible. When a rule is determined beforehand such that a DR target day is the next day of a transmission day of the DR information or the day after a fixed number of days, the DR target period may be omitted. Also, when a rule is determined beforehand such that the power price indicated in the DR information is to be applied only in a specific time period, the configuration for which only one, two or more power prices are included in the DR information is possible and, in this case, it is not necessary to set the power price by the time unit such as the unit of 15 minutes or the unit of 30 minutes.

There may be variation in the standard for the success/failure of DR information transmission varies. Here, only the case that, as a result of transmitting the DR information, information indicating transmission success is returned from the aggregator 104 or the EMS is defined as “transmission success” and the rest is defined as “transmission failure”. For instance, when the transmission method is HTTP, HTTP 200 OK corresponds to the information indicating the transmission success. In the case of the transmission success as a result of transmitting the DR information to the aggregator 104, “transmission success” is determined for all the EMSs subordinate to the aggregator 104. Conversely, in the case of the transmission failure, “transmission failure” is determined for all the EMSs subordinate to the aggregator 104.

As the recognition information indicating whether or not the power consumer has checked the DR information, in the example illustrated in FIG. 4, “recognition level” is used. In this embodiment, the recognition level defines three levels. A level 1 indicates that the DR information has not reached the EMS (has not been normally received). A level 2 indicates that the DR information has reached the EMS but the power consumer has not checked the DR information. A level 3 indicates that the DR information has reached the EMS and the power consumer has checked the DR information. The recognition level is acquired by a recognition level grasping unit 206 inquiring the EMS and the aggregator 104 after the DR information is transmitted. An acquisition method is described in detail later. “Acquisition failure” indicates the case of failing in acquisition of the recognition level. For instance, the case that communication itself cannot be performed with the EMS and the recognition level cannot be acquired corresponds to “acquisition failure”.

An information collecting unit 207 collects information on power consumption (power consumption result) of the respective EMSs. The collected power consumption result is recorded in a power consumption information storage 208. The unit time of the power consumption result is equal to the unit time of the power price specified in the DR information. When the power price is specified by the unit of 15 minutes, the power consumption result is also summed up and collected by the unit of 15 minutes.

A billing amount calculating unit 209 calculates billing amounts for the respective EMSs at a fixed interval (one month, for instance). The billing amount is basically calculated on the basis of the power consumption result of one month and (the power price in) the DR information issued for the EMS during the period of time. The billing amount is calculated after correcting the power price according to a transmission result (success/failure) of the DR information and the recognition level. Details will be described in a part of the description of billing amount calculating processing later.

Hereinafter, DR issuing processing by the DR issuing system 101 will be described.

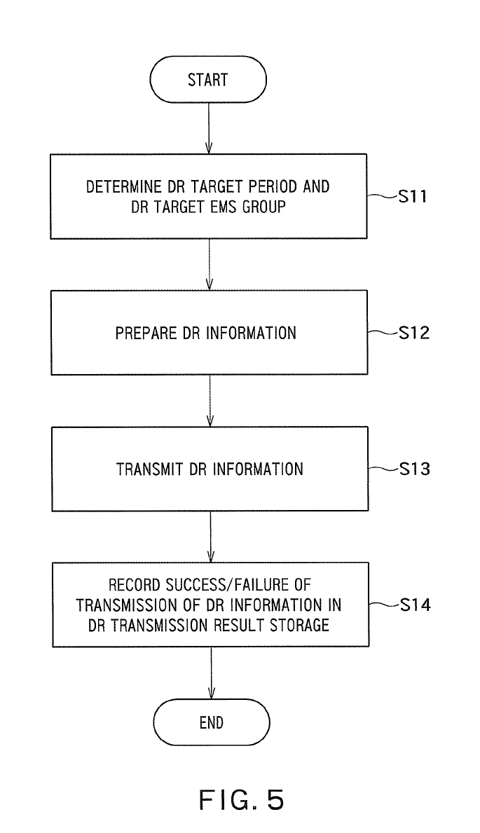

FIG. 5 is a flowchart illustrating flow of the DR issuing processing by the DR issuing system 101.

Step S11: The DR execution determining unit 201 determines the DR target period and a target EMS group.

Step S12: When execution of the DR is determined, the DR information preparing unit 202 prepares the DR information.

Step S13: The DR information transmitting unit 203 transmits the DR information to the EMSs included in the EMS group determined by the DR execution determining unit 201.

Step S14: The DR information transmitting unit 203 records the DR information, the transmission destination of the DR information, and the success/failure of the transmission of the DR information in the DR transmission result storage 205.

These steps are processing of DR issuance.

The EMS connected to the DR issuing system 101 directly (not via the aggregator 104) presents the DR information to the power consumer when the DR information is received. A presentation method is, for instance, transmitting e-mail to a smartphone or a cellular phone, performing display on a display of a personal computer, a television or a photo frame or the like, ringing sound from a speaker of a personal computer or a television or the like, or sounding an alarm provided in a building, or the like. When the terminal device is not the EMS but is a smartphone or a cellular phone, e-mail is directly transmitted from the DR information transmitting unit 203 to the smartphone or the cellular phone.

When the power consumer recognizes the presented DR information, the recognition level of the DR information is recorded inside the EMS. Or, only presence/absence of recognition of the DR information by the power consumer may be recorded and the recognition level may be calculated in the DR issuing system 101.

It can be determined that the power consumer has recognized the DR information from an action of the power consumer. The action of the power consumer is replying to e-mail, clicking a confirmation button displayed on a display or stopping sound made by a speaker or an alarm, or the like.

When the DR information is received, the aggregator 104 transfers the DR information to the subordinate EMSs. A method of transfer may be the same as or different from the method in the DR information transmitting unit 203. For instance, a communication method of BACnet/IP or LonTalk or the like may be used. The aggregator 104 records whether or not the DR information has been successfully transferred for each EMS. Each EMS to which the DR information is transferred presents the DR information to the power consumer and records the recognition level of the DR information or the presence/absence of the recognition of the DR information by the power consumer as described above.

At the time which is T1 earlier than the start time of the DR target period, the aggregator 104 acquires the recognition level of the DR information of the power consumer or the presence/absence of the recognition of the DR information by the power consumer from the subordinate EMSs and records it inside the aggregator 104.

Next, processing of grasping the recognition level will be described.

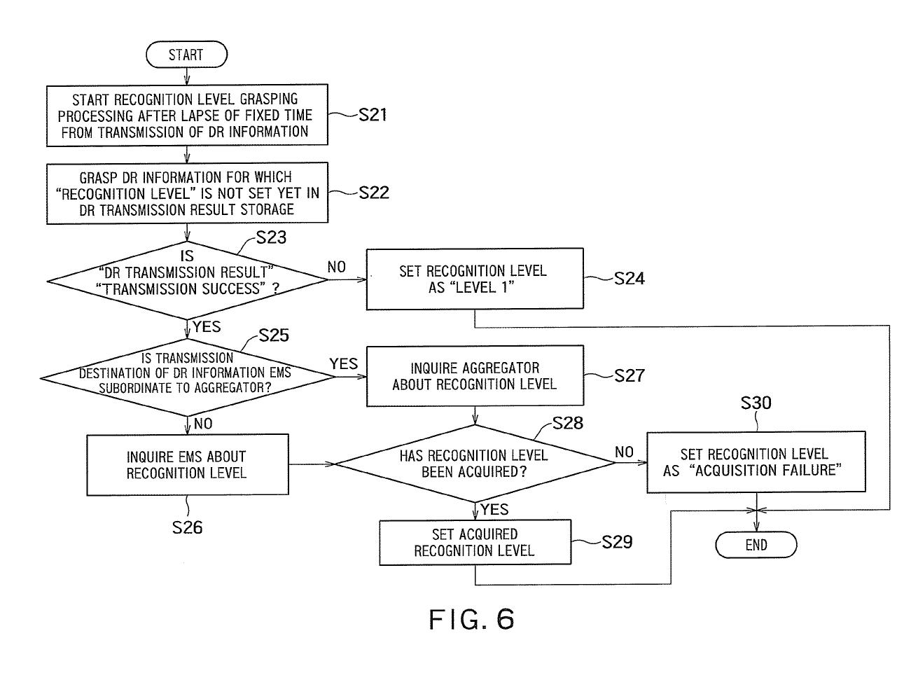

FIG. 6 is a flowchart indicating flow of recognition level grasping processing by the DR issuing system 101.

Step S21: The recognition level grasping unit 206 starts grasping processing of the recognition level at the time which is T2 earlier than the start time of the DR target period after the transmission of the DR information. T2 is shorter than T1. That is, the aggregator 104 grasps the recognition levels of the respective EMSs before the recognition level grasping unit 206 grasps the recognition levels of the respective EMSs from the aggregator 104.

Step S22: The DR transmission result storage 205 is referred to so as to grasp the DR information for which the recognition level is not set yet, and the transmission destination (the aggregator or the EMS) of the DR information is checked. For each transmission destination of the DR information, the following processing is performed. Thus, the recognition level grasping unit 206 grasps recognition situations of all the EMSs.

Step S23: Whether or not “DR transmission result” is “transmission success” is checked, and in the case of “transmission failure”, the recognition level is determined as follows, depending on the transmission destination (step S24). That is, when the transmission destination is the EMS, the recognition level of the EMS is defined as the level 1 (the DR information has not reached the EMS). When the transmission destination is the aggregator, all the recognition levels of the EMSs subordinate to the aggregator are defined as the level 1.

Step S25: When the DR transmission result is “transmission success”, whether the transmission destination is the EMS or the aggregator 104 is checked.

When the transmission destination is the EMS, the recognition level grasping unit 206 inquires the EMS about the recognition level (step S26). The EMS returns information of the recognition level to the recognition level grasping unit 206. The recognition level returned by the EMS is the level 2 (the power consumer has not checked the DR information) or the level 3 (the power consumer has checked the DR information). When only the presence/absence of the recognition is returned, the recognition level is determined in the recognition level grasping unit 206, and is determined as the level 2 when there is no recognition and as the level 3 when there is the recognition.

When the transmission destination is the aggregator 104, the recognition level grasping unit 206 inquires the aggregator 104 about the recognition level (step S27). The aggregator 104 returns the information of the recognition levels acquired from the subordinate EMSs to the recognition level grasping unit 206. For each EMS, the level 1 (the transfer of the DR information to the EMS has failed), or the level 2 (the transfer has been successful but the power consumer has not checked the DR information), or the level 3 (the transfer has been successful and the power consumer has checked the DR information) is returned.

The aggregator 104 may collect the information of the presence/absence of the recognition from the subordinate EMSs and return the result (success/failure) of the transmission to the subordinate EMSs to the recognition level grasping unit 206. In this case, in the recognition level grasping unit 206, the recognition levels are determined for the EMSs subordinate to the aggregator 104. Or, instead of the recognition level grasping unit 206, the aggregator 104 may calculate the recognition levels and return them to the recognition level grasping unit 206.

The recognition level grasping unit 206 checks whether the recognition level has been acquired for each EMS (S28), and records the acquired recognition level in an item of “recognition level” in the DR transmission result storage 205 for the EMS for which the recognition level has been acquired (S29). In the case of having failed in acquisition of the recognition level, it is determined that the acquisition of the recognition level has been a failure, and “acquisition failure” is recorded in the DR transmission result storage 205 (S30). As the case of failing in the acquisition of the recognition level, for instance, the case that a power source of the terminal device is turned off and communication cannot be performed or the like is possible.

Next, information collecting processing by the DR issuing system 101 will be described.

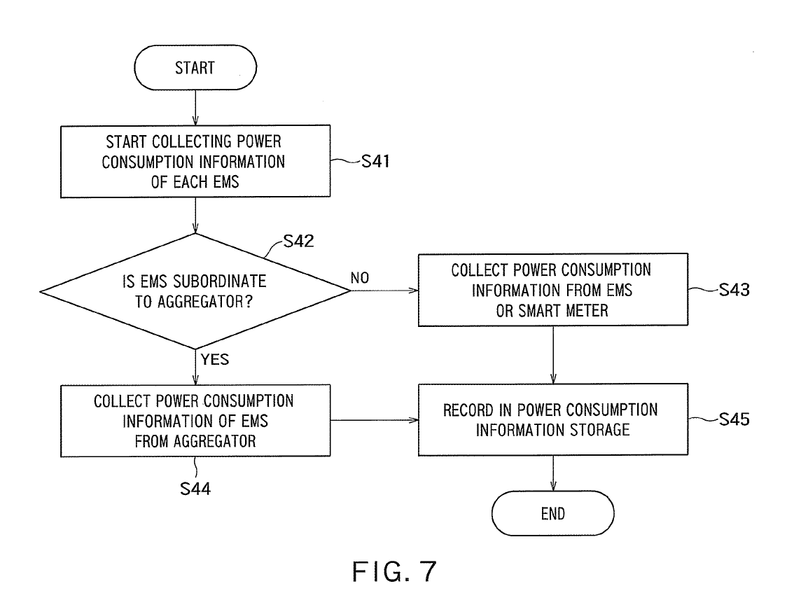

FIG. 7 is a flowchart illustrating flow of the information collecting processing by the DR issuing system 101.

In step S41, the information collecting unit 207 starts collecting the result information (the power consumption result) of the power consumption of all the EMSs at a fixed interval.

In step S42, whether or not the EMS is subordinate to the aggregator is checked. When it is not subordinate, the power consumption result is acquired from the EMS, or from a smart meter when the power consumer is provided with the smart meter (S43). When the EMS is subordinate to the aggregator 104, the power consumption results of the respective EMSs belonging to the aggregator 104 are acquired from the aggregator 104 (S44).

When the terminal device of the power consumer is a smartphone or a cellular phone, it is possible to transmit the power consumption result from the EMS or the like to the smartphone or the cellular phone beforehand and acquire the power consumption result from the terminal device. Conversely, it is possible that the terminal device of an acquisition destination of the recognition level is a smartphone or the like and the power consumption result is collected from the EMS.

In step S45, the information collecting unit 207 records the collected power consumption results in the power consumption information storage 208.

Next, billing processing will be described.

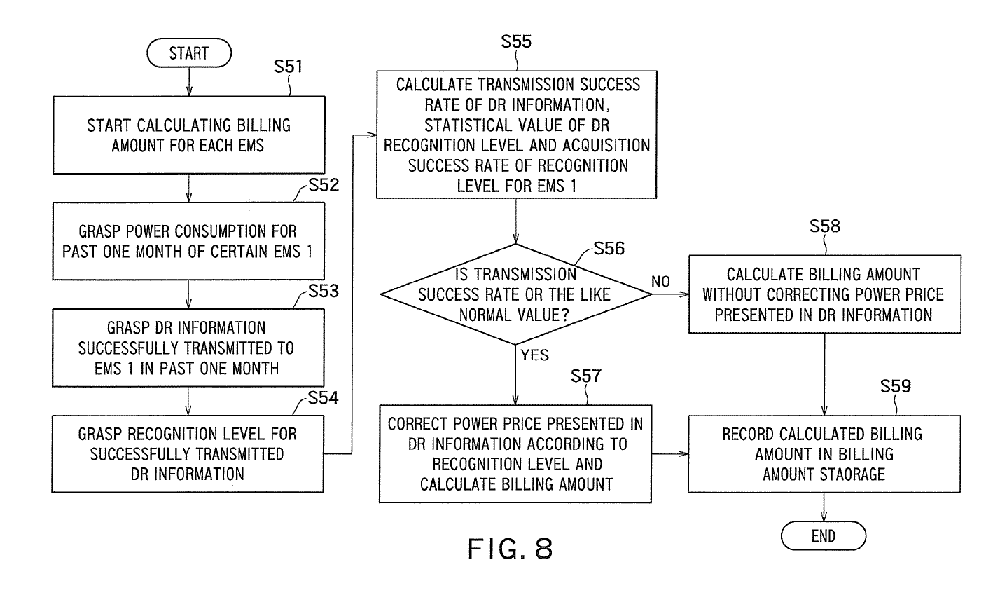

FIG. 8 is a flowchart illustrating flow of the billing processing by the DR issuing system 101.

In step S51, the billing amount calculating unit 209 starts calculating the billing amount at a fixed interval (one month, for instance).

The billing amount calculating unit 209 performs the following processing for each EMS.

In step S52, the power consumption information storage 208 is referred to, and the power consumption result for the past one month of the EMS is grasped.

In step S53, the DR transmission result storage 205 is referred to, and the DR information successfully transmitted to the EMS in the past one month is grasped.

In step S54, the DR transmission result storage 205 is referred to, and the recognition level for the DR information successfully transmitted to the EMS is grasped.

From the power consumption result for each unit time and the power price for each unit time, the billing amount for the past one month is calculated (S55-S59). Hereinafter, details are indicated.

In step S55, a transmission success rate of the DR information, a statistical value (an average value or an intermediate value or the like) of the recognition level, and an acquisition success rate of the recognition rate are calculated.

The transmission success rate can be calculated from the number of times of success/the number of times of transmission. When the same DR information is transmitted for multiple times by retransmission, the number of times of transmission may be counted as one. A calculation target period may be the past one month to be a billing target, any prescribed period in the past, or other periods.

In calculation of the statistical value of the recognition level, a value allocated to each recognition level is used. For instance, 1 is allocated to the level 1, 2 is allocated to the level 2, 3 is allocated to the level 3, and a prescribed value 1.5 is allocated when the recognition level cannot be grasped. Then, using these values, the statistical value is calculated.

The acquisition success rate can be calculated from the number of times of success/the number of times of acquisition trial. The calculation target period may be the past one month to be the billing target, any prescribed period in the past, or other periods.

In step S56, whether or not the transmission success rate, the statistical value and the acquisition success rate that are calculated in step S55 are normal values is determined by comparing them with respective thresholds. When even one of them is below the threshold, it is determined as an abnormal value.

In step S57, when the transmission success rate, the statistical value and the acquisition success rate are all equal to or greater than the thresholds, that is, when they are normal values, the power price presented in the DR information is corrected according to the recognition level and the billing amount is calculated.

Specifically, the power price for the DR target period is the power price specified in the DR information, and the following correction depending on the recognition level is performed at the time. The power price for the time other than the DR target period is a usual price determined beforehand.

(1) When the recognition level is the level 3, there is no correction (that is, correction of 0% reduction).

(2) When the recognition level is the level 2, the power price for the peak time period is reduced by X %.

(3) When the recognition level is the level 1, the power price for the peak time period is reduced by Y %.

(4) When the recognition level cannot be grasped (in the case of the acquisition failure), the power price for the peak time period is reduced by Z %.

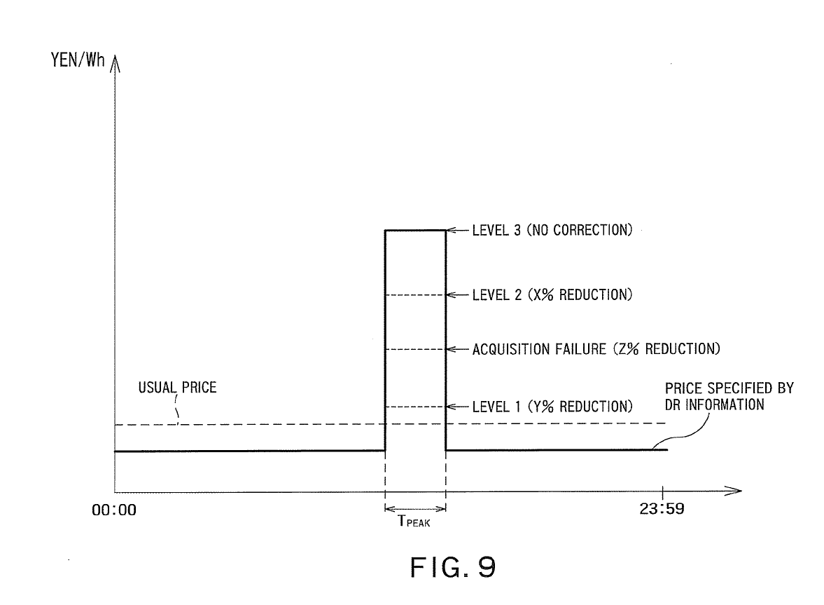

FIG. 9 illustrates an example of the power price specified in the DR information (the power price for the DR target period) and the usual price (the power price for a day which is not the DR target period). Depending on the recognition level, the power price for the peak time period T_{PEAK} is corrected in accordance with one of the four cases (1)-(4). In this example, there is relation of Y>Z>X.

In step S58, when even one of the transmission success rate, the statistical value and the acquisition success rate is below the threshold, that is, when even one of them is the abnormal value, the billing amount is calculated without correcting the power price presented in the DR information (that is, with the correction of 0% reduction).

That is, by not executing the correction for the EMS for which the transmission success rate is below the threshold, the power consumer is prevented from aiming at the reduction of the power price for the peak time by turning off a power source of the terminal device or the like and deliberately not receiving the DR information. Also, by not executing the correction for the EMS for which the statistical value is below the threshold, the power consumer is prevented from aiming at the reduction of the power price for the peak time by deliberately not checking the DR information. Also, by not executing the correction for the EMS for which the acquisition success rate is below the threshold, the power consumer is prevented from aiming at the reduction of the power price for the peak time by deliberately not returning recognition level information.

In step S59, the billing amount calculated in step S57 or S58 is recorded in a billing amount storage 210.

So far, descriptions have been given through a procedure of starting communication from an upper-layer system to a lower-layer system. However, there are cases that it is difficult to start communication from the upper-layer system to the lower-layer system. For instance, when the building is a house, if there is a broadband router which executes NAT (Network Address Translation), it is difficult to start communication from the upper-layer system to the lower-layer system. In this case, by taking a procedure of starting communication from the lower-layer system to the upper-layer system, the processing described in this embodiment can be realized.

Also, respective units inside the DR issuing system 101 may be operated on the same computer, or may be operated on different physical computers that work together. Processing units inside the DR issuing system 101 may be gathered into one server, storages may be gathered into a different server and the servers may work together. In any packaging, the processing described in this embodiment can be realized.

As described above, by this embodiment, the recognition level of the DR information for the power consumer is grasped, the power price is corrected depending on the recognition level and then the billing amount is calculated. When the recognition level is low for instance, the power price is lowered, and the billing amount is reduced. Thus, since the billing amount is reduced when the DR information does not reach the system of the power consumer or the like, billing avoiding increase of complaints of the power consumer is made possible.

While the power price is determined using the recognition level of the power consumer in this embodiment, it is possible to utilize the recognition level for things other than determination of the power price as well. For instance, it is possible to transmit the recognition level of the power consumer to a power company system and allow a power company to plan or correct a power generation schedule utilizing the recognition level.

The DR issuing system may also be realized using a general-purpose computer device as basic hardware. That is, the elements of the system can be realized by causing a processor mounted in the above described computer device to execute a program. In this case, the system may be realized by installing the above described program in the computer device beforehand or may be realized by storing the program in a storage medium such as a CD-ROM or distributing the above described program over a network and installing this program in the computer device as appropriate. Furthermore, each storage in the system may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information communication system comprising:
an information transmitting unit configured to transmit first information specifying a power price to a terminal device of a power consumer; and
an information receiving unit configured to receive second information indicating whether the power consumer has recognized the first information from the terminal device or a different terminal device of the power consumer.

2. The system according to claim 1, wherein
the information transmitting unit is configured to transmit the first information to an aggregator which subordinates the terminal device of the power consumer, and
the information receiving unit is configured to receive the second information indicating whether the power consumer has recognized the first information, from the aggregator.

3. The system according to claim 1, further comprising
a calculating unit is configured to correct the power price on the basis of the second information.

4. The system according to claim 1, comprising a collecting unit and a calculating unit, wherein
the information transmitting unit is configured to transmit the first information to the terminal device or an aggregator which subordinates the terminal device of the power consumer,
the information receiving unit is configured to receive the second information from the terminal device or the different terminal device or the aggregator,
the collecting unit is configured to acquire third information indicating power consumption of the power consumer from the terminal device, the different terminal device or the aggregator, and
the calculating unit is configured to calculate a billing price to the power consumer on the basis of the third information and the second information.

5. The system according to claim 4, wherein the calculating unit is configured to correct the power price on the basis of the second information and calculate the billing price on the basis of a corrected power price and the third information.

6. The system according to claim 5, wherein the second information indicates one of a plurality of states including:
a first state in which the first information has not reached the terminal device;
a second state in which the first information has reached the terminal device but has not been recognized by the power consumer; and
a third state in which the first information has reached the terminal device and has been recognized by the power consumer.

7. The system according to claim 6, wherein the calculating unit is configured to
calculate a success rate of transmission of the first information to the terminal device, and
correct the power price on the basis of the transmission success rate.

8. The system according to claim 6, wherein the calculating unit is configured to
calculate a recognition rate of the first information for the power consumer, and
correct the power price on the basis of the recognition rate.

9. The system according to claim 6, wherein the calculating unit is configured to
calculate an acquisition success rate or acquisition failure rate of the second information for the information receiving unit, and
correct the power price on the basis of the acquisition success rate or the acquisition failure rate.

10. The system according to claim 4, wherein
the first information includes specification of the power price for each of a plurality of time periods, and
the power price is corrected only for a specific time period among the plurality of time periods.

11. The system according to claim 1, further comprising
a storage configured to store a history of the second information received by the information receiving unit for the power consumer.

12. An method comprising:
transmitting first information specifying a power price to a terminal device of a power consumer; and
receiving second information indicating whether the power consumer has recognized the first information from the terminal device or a different terminal device of the power consumer.

13. A non-transitory computer readable medium having instructions stored therein which causes, when executed by a computer, to execute steps comprising:
transmitting first information specifying a power price to a terminal device of a power consumer; and
receiving second information indicating whether the power consumer has recognized the first information from the terminal device or a different terminal device of the power consumer.
